(19) United States
(12) Patent Application Publication
(10) Pub. No.: US 2025/0343742 A1
(43) Pub. Date: Nov. 6, 2025

(54) AT Commands for New Radio Quality of Experience (QoE) Management

(71) Applicant: Apple Inc., CUPERTINO, CA (US)

(72) Inventors: Vivek G GUPTA, San Jose, CA (US); Pavan NUGGEHALLI, San Carlos, CA (US); Dipannita DEY, Bangalore (IN)

(21) Appl. No.: 18/862,303

(22) PCT Filed: May 2, 2023
(86) PCT No.: PCT/US2023/020658

§ 371 Date: Nov. 1, 2024

(30) Foreign Application Priority Data
May 3, 2022 (IN) 202241025708

(51) Int. Cl. H04L 41/5067

(52) U.S. Cl. CPC H04L 41/5067

(57) ABSTRACT

A user equipment (UE) implements a terminal equipment (TE), a mobile termination (MT) and a terminal adapter (TA). The UE transmits, by the TE, an attention (AT) command for quality of experience (QoE) application layer configuration to the TA, wherein the AT command is configured to control a presentation of an unsolicited return code in response to a radio resource control (RRC) message received by the UE from a network comprising an application layer measurement configuration information element (IE) and receives, by the TE, the unsolicited result code comprising one or more parameters related to new radio (NR) QoE application layer measurements and associated with a measurement configuration application layer ID, wherein the one or more parameters in the unsolicited result code are received from the network in the application layer measurement configuration IE.

### BACKGROUND

A user equipment (UE) architecture may include terminal equipment (TE) and mobile termination (MT) functions interfaced by a terminal adapter (TA). An attention (AT) command may be sent by the TE to the TA and be used to control MT behavior. It has been identified that there is a need for AT commands configured to support fifth generation (5G) new radio (NR) quality of experience (QoE) management.

### SUMMARY

In some exemplary embodiments one or more processors of a user equipment (UE) implement a terminal equipment (TE), a mobile termination (MT) and a terminal adapter (TA). The one or more processors perform operations including transmitting, by the TE, an attention (AT) command for quality of experience (QoE) application layer configuration to the TA, wherein the AT command is configured to control a presentation of an unsolicited return code in response to a radio resource control (RRC) message received by the UE from a network comprising an application layer measurement configuration information element (IE) and receiving, by the TE, the unsolicited result code comprising one or more parameters related to new radio (NR) QoE application layer measurements and associated with a measurement configuration application layer ID, wherein the one or more parameters in the unsolicited result code are received from the network in the application layer measurement configuration IE.

Other exemplary embodiments are related to one or more processors of a user equipment (UE) implementing a terminal equipment (TE), a mobile termination (MT) and a terminal adapter (TA). The one or more processors perform operations including transmitting, by the TE, an attention (AT) command for quality of experience (QoE) measurement reporting to the TA, wherein the AT command comprises one or more parameters including a parameter identifying an application layer measurement, the one or more parameters configured to set parameters for the UE to include in an application layer measurement report and transmitting a radio resource control (RRC) message to a next generation (NG) radio access network (RAN) comprising a measurement report application layer message based on the AT command.

### BRIEF DESCRIPTION OF THE DRAWINGS

FIG. 1 shows an exemplary architecture according to various exemplary embodiments.

FIG. 2 shows a command and response table for the exemplary quality of experience (QoE) application layer configuration attention (AT) command according to various exemplary embodiments.

FIG. 3 shows a command and response table for the exemplary QoE measurement reporting AT command according to various exemplary embodiments.

FIG. 4 shows a method for application layer measurement configuration for fifth generation (5G) new radio (NR) QoE management according to various exemplary embodiments.

FIG. 5 shows a method for QoE measurement reporting for 5G NR QoE management according to various exemplary embodiments.

FIG. 6 shows an exemplary network arrangement according to various exemplary embodiments.

FIG. 7 shows an exemplary UE according to various exemplary embodiments

### DETAILED DESCRIPTION

The exemplary embodiments may be further understood with reference to the following description and the related appended drawings, wherein like elements are provided with the same reference numerals. The exemplary embodiments introduce attention (AT) commands configured to support fifth generation (5G) new radio (NR) quality of experience (QoE) management.

The exemplary embodiments are described with regard to an exemplary user equipment (UE) architecture comprising a terminal equipment (TE) and mobile termination (or mobile terminal) (MT) interfaced by a terminal adaptor (TA). An AT command may be sent by the TE to the TA and may be utilized as an internal interface within the UE between the application layer and the radio interface layer. However, reference to a UE is merely provided for illustrative purposes. The exemplary embodiments may be utilized with any electronic component that is configured with the hardware, software, and/or firmware to implement this type of exemplary architecture and perform 5G NR QoE measurements.

In the below description, various information elements (IEs) and parameters have been referred to by a name. It should be understood that these names are only exemplary and the IEs and parameters may be referred to by other names or no names at all.

In 5G NR, QoE management may be implemented to ensure an adequate user perceived quality of experience when using certain multimedia services. For example, 5G NR QoE measurement mechanisms may collect experience parameters for services such as, but not limited to, enhanced mobile broadband (eMBB), ultra-reliable low latency communication (URLLC), streaming, multimedia telephony service over IMS (MTSI), multimedia broadcast multicast services (MBMS), extended reality (XR), virtual reality (VR), etc. 5G NR QoE management may also include mechanisms for activation, deactivation, configuration, mobility support and reporting QoE measurements. In addition, 5G NR QoE management may support features such as, but not limited to, multiple simultaneous QoE measurements at the UE, QoE measurement handling during RAN overload and per-slice QoE measurements.

It has been identified that there is a need for AT commands configured to support 5G NR QoE management. As will be described in more detail below, the exemplary embodiments utilize AT commands to configure the manner in which the TE may receive QoE measurement related configuration information from the MT, send QoE measurement reports from upper layers to the network via the MT and indicate to upper layers about the release of application layer measurements.

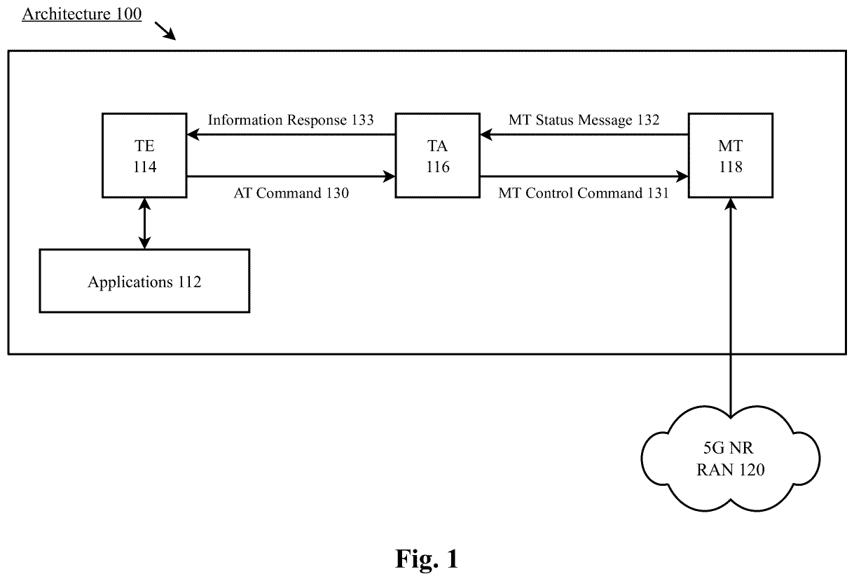

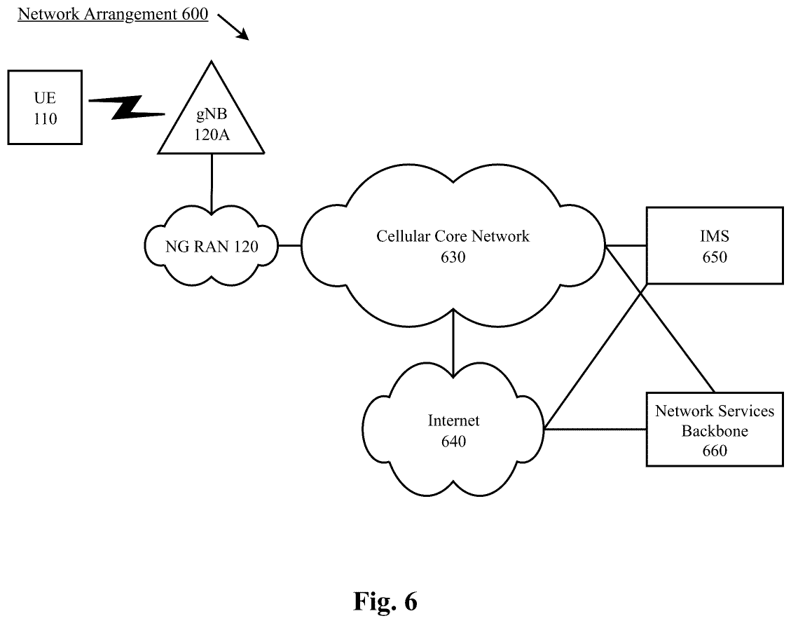

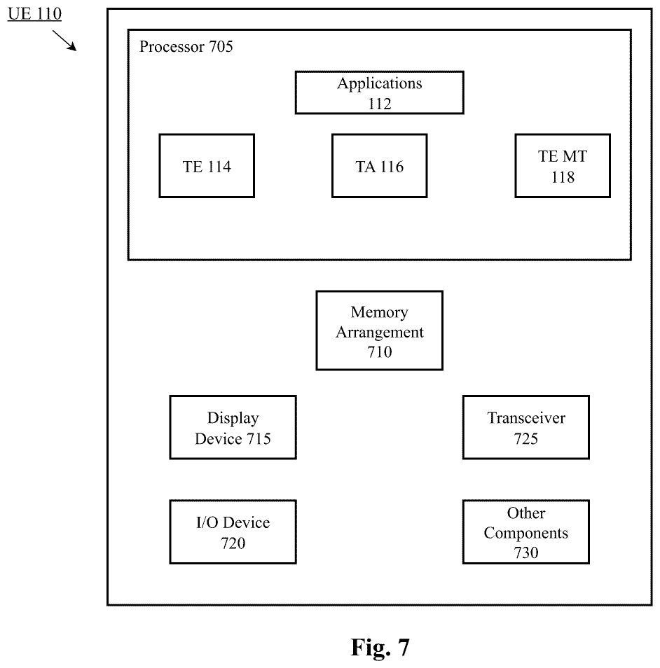

FIG. 1 shows an exemplary architecture 100 according to various exemplary embodiments. The exemplary UE architecture 100 may include one or more applications 112 executed by an application processor or any appropriate type of processing circuitry of the UE 110. Additional details regarding the UE 110, the NG RAN 120 and an exemplary network arrangement are provided below with regard to FIGS. 6-7.

In addition, the exemplary architecture 100 includes a UE architecture comprising a TE 114, a TA 116 and a MT 118. The MT 118 may send and receive messages from one or more networks. In this example, the network is a next generation (NG) radio access network (RAN) 120. While the exemplary embodiments may be used to support QoE management in a NG RAN, the exemplary embodiments are not limited to this type of network and may apply to any appropriate type of network.

The TE 114 may be communicatively coupled to the MT 118 via the TA 116. In some embodiments, the TE 114 may be executed by the application processor of the UE 110 and the MT 118 may be executed by the baseband processor of the UE 110. However, the exemplary embodiments are not limited to this arrangement of processors and entities, the exemplary architecture 100 may be implemented using any appropriate type of processing component or circuitry (e.g., application, baseband, etc.) and any appropriate number of entities. For instance, in some examples, the TE 114, the MT 118 and the TA 116 may be implemented as a single entity or three separate entities. In other examples, the TA 116 may be integrated under the MT 118 and the TE 114 may be implemented as a separate entity or the TA 116 may be integrated under the TE 114 and the MT 118 may be implemented as a separate entity.

During operation, the one or more applications 112 running on the UE 110 may be configured to perform various operations for 5G QoE management. Accordingly, the one or more applications 112 may transmit signals to the TE 114 indicating, for example, a value of an application layer 5G QoE measurement parameter or a request to read a 5G QoE measurement configuration. In response, the TE 114 may generate and transmit an AT command 130 to the TA 116. The AT command 130 may be processed by the TA 116 and then an MT control command 131 or any other appropriate type of message may be sent to the MT 118.

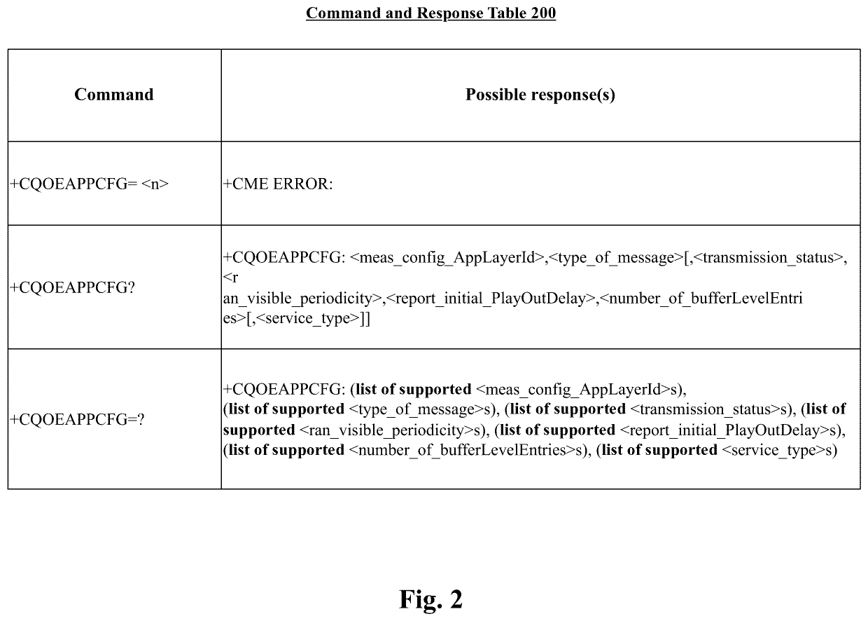

The AT command may be utilized as an internal interface within the UE 110 between the application layer and the radio interface layer. As indicated above, the AT command may be configured to control the behavior of the MT 118. For example, an AT command may be used to configure the manner in which the TE 114 is to receive configuration information from the network via the MT 118. In another example, the AT command may be used to set the parameters the MT 118 is to send to the NG RAN 120 in an application layer measurement report. However, these AT commands are merely provided for illustrative purposes and are not intended to limit the exemplary embodiments in any way. These examples are provided as a general overview of the types of interactions that may occur between the TE 114, the TA 116 and the MT 118. The exemplary AT commands introduced herein are described in detail below with regard to FIGS. 2-5.

The MT 118 may send an MT status message 132 to the TA 116. The contents of the MT status message may be based on the command 130. For example, the AT command 130 may configure the MT 118 to perform a particular operation in response to an event. When the event occurs, the MT 118 may be triggered to send the MT status message to the TA 116 comprising data related to the previously received AT command 130. In other examples, the MT status message 132 may include data indicating an intermediate status of a task or operation to be performed in response to the AT command 130 or may include a data indication that a task or operation to be performed in response to the AT command 130 is complete.

The TA 116 may send an information response 133 comprising a result code. Those skilled in the art will understand that the result code may be characterized as a final result code sent in response to an AT command, an intermediate result code configured to inform the TE 114 of the process of TA operation or an unsolicited result code configured to indicate the occurrence of an event not directly associated with issuance of an AT command. These examples are provided as a general overview of the types of messages that may be sent to the TE 114 by the TA 116. The particular messages that are to be sent in response to the exemplary AT commands introduced herein are provided in detail below with regard to FIGS. 2-5.

5G NR QoE measurement reporting may include sending application layer measurement reports to the network. A UE capable of application layer measurement reporting in RRC CONNECTED mode may initiate the procedure when configured with an appLayerMeasConfig IE in an RRC message. The UE 110 may indicate its capability to support 5G NR QoE in a 5G mobility management (5GMM) capability IE in a REGISTRATION REQUEST message. The network may indicate its support of 5G NR QoE in a 5G system (5GS) network feature support IE in a REGISTRATION ACCEPT message.

Prior to discussing the exemplary AT commands introduced herein, the following description provides some examples of why there is a need for these exemplary AT commands. For 5G QoE management, the access stratum (AS) layer may indicate to the application layer whether a session start and end indication is required for a particular application layer measurement configuration ID (e.g., measConfigAppLayerID). To provide an example, for each measConfigAppLayerID value included in the measConfigAppLayerToAddModList information element (IE), the transmissionofSessionStartStop is to be forwarded to upper layers if received. In addition, the application layer may send a session start or end indication with a particular application layer measurement configuration ID for the required application layer measurement configuration if there is a session start or end. For example, if session start or stop information has been received from upper layers for a measConfigAppLayerID, the applicationLayerSessionStatus is to be set to whether a QoE session in the application later starts or stops. However, there are currently no AT commands configured to enable this functionality. As will be described in more detail below, the exemplary AT commands introduced herein may be utilized to facilitate the example operations described above.

The network may configure the UE 110 for RAN visible application layer measurements. This may include sending RAN visible application layer measurement configuration information to the UE 110. For example, the network may send a ran-VisibleParameters IE configured for RAN visible application layer configuration setup to the UE 110 and the corresponding parameters (e.g., ran-VisiblePeriodicity, numberOfBufferLevelEntries, reportInitialPlayOutDelay) are to be forwarded to upper layers. In another example, the network may release a list of RAN visible application layer measurement configurations while not releasing the corresponding legacy application layer measurement configurations. For example, if the ran-VisibleParameters IE is configured to release a RAN visible application layer configuration, the upper layers are not informed about the release of the RAN visible application layer configuration. However, there are currently no AT commands configured to enable this functionality. As will be described in more detail below, the exemplary AT commands introduced herein may be utilized to facilitate the example operations described above.

The network may also configure RAN visible application layer measurement reporting at the UE 110. A RAN visible application layer measurement report may comprise a packet data unit (PDU) session ID, a buffer level, an initial playout delay and any other appropriate type of parameter. During operation, upper layers may receive the RAN visible application layer measurement report. For each applicationLayerBufferLevel value in the received RAN visible application layer report, set the applicationLayerBufferLevel values in the applicationLayerBufferLevelList to the buffer level values received from the upper layers in the order with the first applicationLayerBufferLevel value set to the newest received buffer level value, the second applicationLayerBufferLevel value set to the second newest receive buffer level value and continuing until all the buffer level values received from the upper layer have been assigned or the configured maximum number of applicationLayerBufferLevel values have been set. The initialPlayoutDelay may be set to the received value in the RAN visible application layer measurement report (if any). Further, for each PDU sessionID value indicated in the received RAN visible application layer measurement report, set the PDU-SessionID field in the pduSessionIdList to the indicated PDU session ID value. However, there are currently no AT commands configured to enable this functionality. As will be described in more detail below, the exemplary AT commands introduced herein may be utilized to facilitate the example operations described above.

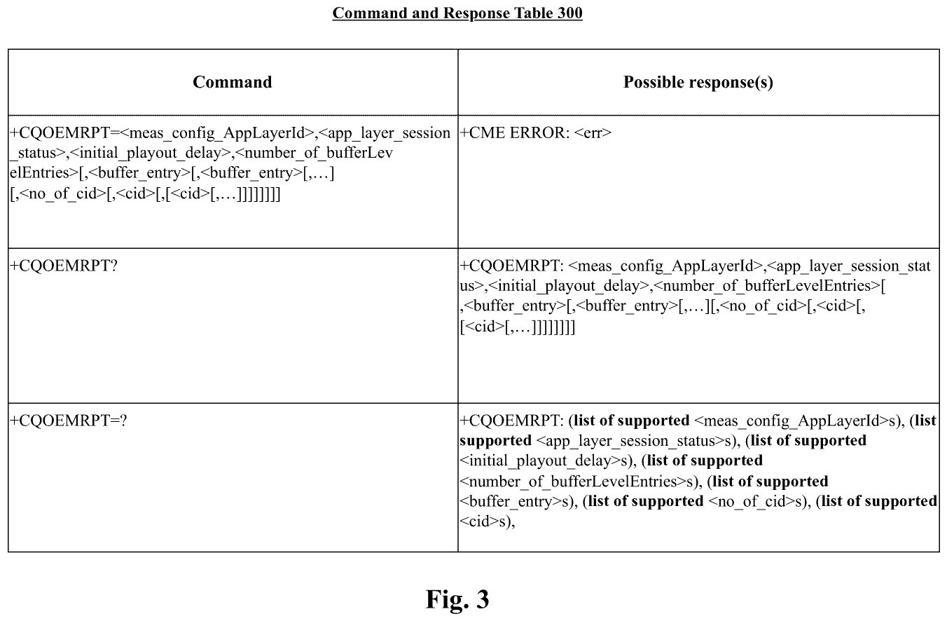

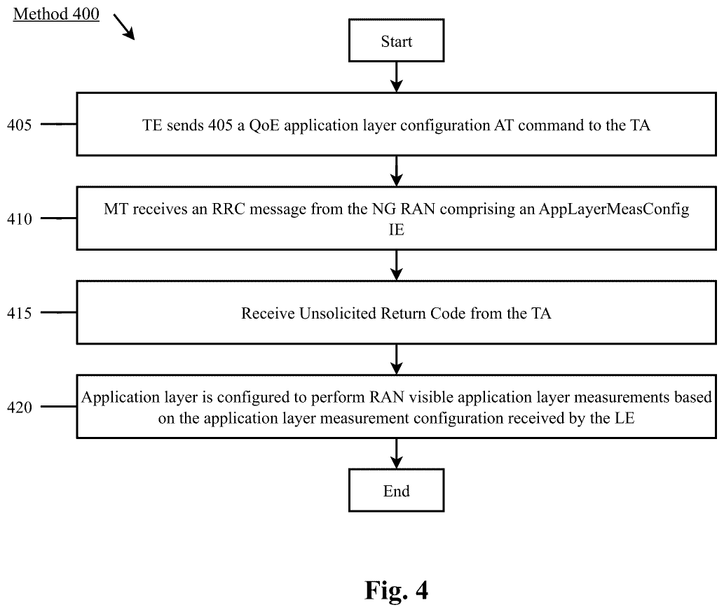

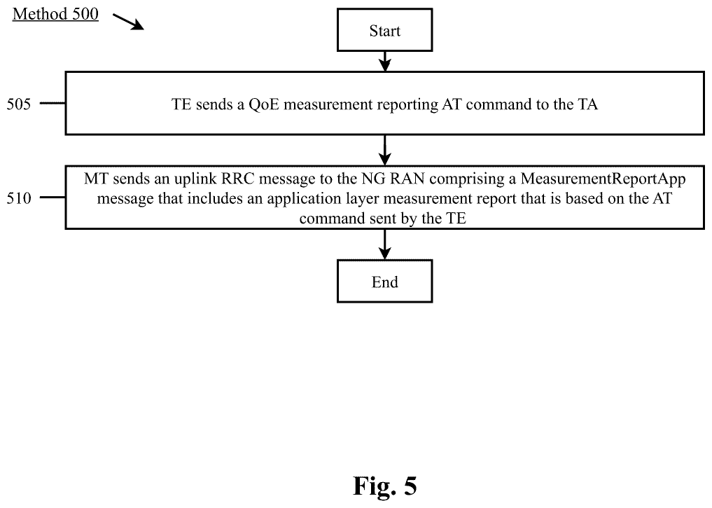

Initially, the exemplary AT commands introduced herein are described with regard to the command and response tables shown in FIGS. 2-3. Subsequently, examples of utilizing these exemplary AT commands are provided below with regard to the methods 400-500 of FIGS. 4-5.

For the command and response tables 200-300 shown in FIGS. 2-3, the following definitions may apply: “< . . . >” a name enclosed in angle brackets is a syntactical element and the brackets themselves do not appear in the command line. “[ . . . ]” an optional sub-parameter of a command or an optional part of TA information response may be enclosed in square brackets and the brackets themselves do not appear in the command line. An underlined defined sub-parameter value (e.g., 0, 1, etc.) represents the recommended default setting of this sub-parameter.

The commands may use syntax rules of extended commands. Every extended command has a test command denoted by a trailing “=?” to test the existence of the command and to give information about the type of its sub-parameters. Parameter type commands also have a read command denoted by a trailing “?” to check the current values of sub-parameters.

The exemplary embodiments introduce a QoE application layer configuration AT command. FIG. 2 shows a command and response table 200 for the exemplary QoE application layer measurement configuration AT command. Throughout this description, this exemplary AT command may be referred to by its parameter command syntax “+CQOEAMC” however, reference to +CQOEAMC is provided for illustrative purposes, different entities may use a different command syntax to refer to the same type of AT command.

For the QoE application layer configuration AT command (+CQOEAMC) shown in the table 200, the set command may control the presentation of the unsolicited result code (provided below and shown in the table 200) wherein the parameters reported in the unsolicited result code are received from the network in an AppLayerMeasConfig IE which may indicate a configuration of application layer measurements. The read command returns the current value of <n> and configuration of application layer measurements.

The unsolicited return code may be provided to the TE 114 in response to an event. Thus, in this example, the AT command may be sent to the TA 116 at a first time to configure the manner in which the application layer measurement configuration information for QoE management is to be provided to the TE 114. Subsequently, at a second time, the MT 118 may receive an AppLayerMeasConfig IE comprising application layer measurement configuration information in an RRC message from the NG RAN 120. The reception of the AppLayerMeasConfig IE may be the triggering event for the unsolicited return code. Thus, in response to the AppLayerMeasConfig IE, the TA 116 may provide an unsolicited return code to the TE 114 comprising parameters for performing application layer measurements for 5G NR QoE management.

As shown in the table 200, the unsolicited return code may be represented by: +CQOEAMCI:

<meas_config_AppLayerId>,<type_of_message>[,<transmission_status >,<ran_visible_periodicity>,<report_initial_PlayOutDelay>,<numbe r_of_bufferLevelEntries>[,<service_type>]]

The follow description provides the defined values for the command and response table 200:

<n>: integer type

0 Disable presentation of unsolicited result code +CQOEAMCI:

1 Enable presentation of unsolicited result code +CQOEAMCI:

<meas_config_AppLayerId>: integer type, identifies the application layer measurement ranging from 1 to 16.

<ranVisibleParameters>: integer type, indicates if the indication is related to setup or release of the RAN visible application layer measurement configuration. If it is release, then only the <meas_config_AppLayerId> is returned.

<transmission_status>: boolean, indicates whether the UE shall transmit indications when sessions in the application layer start and stop. The UE transmits a session start indication upon configuration of this field if a session has already started in the application layer.

<ran_visible_periodicity>: integer type, indicates the periodicity of RAN visible reporting in milliseconds (ms); Values: 120, 240, 480, 640, 1024.

<report_initial_PlayOutDelay>: integer type, indicates whether the UE shall report Initial Playout Delay for RAN visible application layer measurements in ms. Values: 1, 2 up to the maximum value of 30000 ms.

<number_of_bufferLevelEntries>: integer type, indicates the maximum number of buffer level entries that can be reported for RAN visible application layer measurements, ranges from 1 to 8.

<service_type>: integer type, indicates the type of application layer measurement. 1—Streaming, 2—MTSI, 3—Virtual Reality.

In this example, using the syntax rules and definitions provided above, for RAN visible application layer measurement configuration setup, the unsolicited return code may be configured to include a measConfigAppLayerID and an indication that the unsolicited return code is related to setup of the RAN visible application layer measurement configuration (e.g., <ranVisibileParameters>). The other parameters are shown in square brackets “[ . . . ]” and, thus may be optionally included in the unsolicited return code depending on the contents of the corresponding AT command. For RAN visible application layer measurement configuration release, the unsolicited return code may be configured to include a measConfigAppLayerID and an indication that the that the unsolicited return code is related to release of the corresponding RAN visible application layer measurement configuration. Since this message is for release, the other parameters are shown in square brackets “[ . . . ]” are not included. An example of utilizing the exemplary QoE application layer configuration AT command during operation is provided below with regard to the method 400 of FIG. 4.

FIG. 3 shows a command and response table 300 for the exemplary QoE measurement reporting AT command. Throughout this description, this exemplary AT command may be referred to by its parameter command syntax “+CQOEAMR” however, reference to +CQOEAMR is provided for illustrative purposes, different entities may use a different command syntax to refer to the same type of AT command.

For the QoE measurement reporting AT command (+CQOEAMR) shown in the table 300, the set command may be used to set the required parameters for the UE 110 to send the application layer measurement report to the network in an MeasurementReportAppLayer message. The read command may return the current value of the application layer measurements.

The follow description provides the defined values for the command and response table 300:

<meas_config_AppLayerId>: integer type, identifies the application layer measurement ranging from 1 to 15.

<app_layer_session_status>: boolean, indicates whether the QoE session in the UE starts or stops.

<transmission_status>: boolean, indicates whether the UE shall transmit indications when sessions in the application layer start and stop. The UE transmits a session start indication upon configuration of this field if a session has already started in the application layer.

<initial_playout_delay>: integer type, indicates whether the UE shall report Initial Playout Delay for RAN visible application layer measurements in ms. Values: 1, 2 up to the maximum value of 30000 ms.

<number_of_bufferLevelEntries>: integer type, indicates the maximum number of buffer level entries that can be reported for RAN visible application layer measurements, ranges from 1 to 8.

<buffer_entry>: integer type, indicates the application layer buffer level in ms. Value 1 corresponds to 10 ms, value 2 corresponds to 20 ms and so on. If the buffer level is larger than the maximum value of 30000 (5 minutes), the UE reports 30000.

<no_of_cid>: integer type, indicates the number of <cid>s (PDU sessions) following this parameter. Ranges from 1 to 256.

<cid>: integer type; A numeric parameter which specifies a particular 5GS QoS flow. The <cid> parameter is local to the TE-MT interface and identifies only 5GS QoS flows which have been setup via AT command (see the +CGDCONT and +CGDSCONT commands).

An example of utilizing the exemplary QoE measurement reporting AT command during operation is provided below with regard to the method 500 of FIG. 5.

FIG. 4 shows a method 400 for application layer measurement configuration for 5G NR QoE management according to various exemplary embodiments. The method 400 is described with regard to the exemplary architecture 100 of FIG. 1 and the command and response table 200 of FIG. 2.

In 405, the TE 114 sends a QoE application layer configuration AT command (+CQOEAMC) to the TA 116. The TE 114 may be triggered to send the AT command based on any appropriate condition. To provide one example, the one or more applications 112 running on the UE 110 may send a signal to the TE 114 that triggers the AT command.

In the method 400 it is assumed that the AT command is only applicable to NG RANs and is to be used to configure the manner in which the TE 114 is to receive configuration information for application layer measurement operations for 5G NR QoE management. However, in an actual operating scenario, the AT command may be a read command to retrieve the current parameters for application layer measurement configuration and their corresponding values.

In 410, the MT 118 receives an RRC message from the NG RAN 120 comprising an AppLayerMeasConfig IE. The AT command may be used to trigger unsolicited result code to the TE 114 in response to an event. In this example, the event is the reception of an AppLayerMeasConfig IE from the NG RAN 120. However, the exemplary embodiments are not limited to this event being the reception of this IE and any other appropriate signal may be utilized.

In 415, the TE 114 receives the unsolicited return code from the TA 116. If NG RAN 120 sent the AppLayerMeasConfig IE to release a previously configured a RAN visible application layer measurement configuration of a measConfigAppLayerID, the unsolicited return code in 415 may include the measConfigAppLayerID and an indication that the configuration is to be released.

If the NG RAN 120 sent the AppLayerMeasConfig IE to set a RAN visible application layer measurement configuration at the UE 110, the unsolicited return code in 415 may include the measConfigAppLayerID and an indication that this message is for a setup of RAN visible application layer measurement configuration (e.g., <ranVisibleParameters>). In addition, the unsolicited result code may include parameters such as, an indication of whether the UE 110 is to transmit indications when sessions in the application layer start and stop. (e.g., <transmission_status>), a reporting periodicity (e.g., <ran_visible_periodicity>), an indication of whether the UE 110 is to report the initial playout delay for RAN visible application layer measurements (e.g., <report_initial_PlayOutDelay>), a maximum number of buffer level entries that may be reported (e.g., <number of bufferLevelEntries>) and the type of application layer measurement (e. g., <service_type>).

In 420, the application layer is configured to perform RAN visible application layer measurements based on the application layer measurement configuration information received by the TE 114. The application layer may be configured with multiple RAN visible application layer measurement configurations, each corresponding to a different measurement configuration application layer ID.

FIG. 5 shows a method 500 for QoE measurement reporting for 5G NR QoE management according to various exemplary embodiments. The method 500 is described with regard to the exemplary architecture 100 of FIG. 1 and the command and response table 300 of FIG. 3.

In 505, the TE 114 sends a QoE measurement reporting AT command (+CQOEAMR) to the TA 116. The TE 114 may be triggered to send the AT command based on any appropriate condition. To provide one example, the one or more applications 112 running on the UE 110 may collect application layer measurement data that is to be reported to the NG RAN 120. The one or more applications 112 may transmit a signal to the TE 114 to report the application layer measurements to the network.

In the method 500 it is assumed that the AT command is only applicable to NG RANs and is to be used to provide application layer measurements to the MT 118 that are to be reported to the NG RAN 120. However, in an actual operating scenario, the AT command may be a read command to return the current value of the application layer measurements at the MT 118.

The AT command may include an measConfigAppLayerID, an indication of whether the QoE session in the UE 110 starts or stops (e.g., <app_layer_session status>), an indication of whether the UE 110 is to report initial playout delay for RAN visible application layer measurements (e.g., <initial_playout_delay>), a maximum number of buffer level entries that may be reported (e.g., <number_of_bufferLevelEntries>), an application layer buffer level (e.g., <buffer_entry>) and an identify of one or more the QoS flows (e.g., <no_of_cid>and <cid>).

In 510, the MT 118 sends an uplink RRC message to the NG RAN 120 comprising a MeasurementReportAppLayer message that includes an application layer measurement report that is based on the AT command sent by the TE 114. The application layer may be configured with multiple RAN visible application layer measurement configurations, each corresponding to a different measurement configuration application layer ID. Therefore, one or more AT commands may be used to provide information for one or more application layer measurement reports to be provided to the NG RAN 120.

FIG. 6 shows an exemplary network arrangement 600 according to various exemplary embodiments. The exemplary network arrangement 600 includes a UE 110. Those skilled in the art will understand that the UE 110 may be any type of electronic component that is configured to communicate via a network, e.g., mobile phones, tablet computers, desktop computers, smartphones, phablets, embedded devices, wearables, Internet of Things (IoT) devices, etc. It should also be understood that an actual network arrangement may include any number of UEs being used by any number of users. Thus, the example of a single UE 110 is merely provided for illustrative purposes.

The UE 110 may be configured to communicate with one or more networks. In the example of the network architecture 100, the network with which the UE 110 may wirelessly communicate is a NG RAN 120. However, it should be understood that the UE 110 may also communicate with other types of networks (e.g., 5G RAN, 5G cloud RAN, LTE RAN, a legacy cellular network, a wireless local area network (WLAN), etc.) and the UE 110 may also communicate with networks over a wired connection. Therefore, the UE 110 may have a 5G chipset to communicate with the NG RAN 120 and, optionally, any other appropriate type of chipset to communicate with other types of networks.

The NG RAN 120 may be a portion of a cellular network that may be deployed by a network carrier (e.g., Verizon, AT&T, Sprint, T-Mobile, etc.). The NG RAN 120 may include cells and base stations that are configured to send and receive traffic from UEs that are equipped with the appropriate cellular chip set. In this example, the NG RAN 120 includes the gNB 120A. However, reference to a gNB is merely provided for illustrative purposes, the exemplary embodiments may be utilized with any appropriate type of access node may be (e.g., Node Bs, eNodeBs, HeNBs, eNBs, gNBs, gNodeBs, macrocells, microcells, small cells, femtocells, etc.).

Those skilled in the art will understand that any association procedure may be performed for the UE 110 to connect to the NG RAN 120. For example, the NG RAN 120 may be associated with a particular network carrier where the UE 110 and/or the user thereof has a contract and credential information (e.g., stored on a SIM card). Upon detecting the presence of the NG RAN 120, the UE 110 may transmit the corresponding credential information to associate with the NG RAN 120. More specifically, the UE 110 may associate with a base station, e.g., the gNB 120A).

The network arrangement 600 also includes a cellular core network 630, the Internet 640, an IP Multimedia Subsystem (IMS) 650, and a network services backbone 660. The cellular core network 630 may refer an interconnected set of components that manages the operation and traffic of the cellular network. The cellular core network 630 also manages the traffic that flows between the cellular network and the Internet 640. The IMS 650 may be generally described as an architecture for delivering multimedia services to the UE 110 using the IP protocol. The IMS 650 may communicate with the cellular core network 630 and the Internet 640 to provide the multimedia services to the UE 110. The network services backbone 660 is in communication either directly or indirectly with the Internet 640 and the cellular core network 630. The network services backbone 660 may be generally described as a set of components (e.g., servers, network storage arrangements, etc.) that implement a suite of services that may be used to extend the functionalities of the UE 110 in communication with the various networks.

FIG. 7 shows an exemplary UE 110 according to various exemplary embodiments. The UE 110 will be described with regard to the network architecture 100 of FIG. 1. The UE 110 may include a processor 705, a memory arrangement 710, a display device 715, an input/output (I/O) device 720, a transceiver 725 and other components 730. The other components 730 may, for example, an audio input device, an audio output device, a power supply, a data acquisition device, ports to electrically connect the UE 110 to other electronic devices, etc.

The processor 705 may be configured to execute a one or more applications for the UE 110 and the UE entities described above in the exemplary architecture 100, e.g., TE 114, AT 116 and MT 118.

The above referenced one or more applications 112 and UE entities being executed by the processor 705 is merely provided for illustrative purposes. The functionality associated with the one or more applications 112 and each of the TE 114, AT 116, MT 118 may also be represented as separate incorporated components of the UE 110 or may be a modular component coupled to the UE 110, e.g., an integrated circuit with or without firmware. For example, the integrated circuit may include input circuitry to receive signals and processing circuitry to process the signals and other information. In addition, in some UEs, the functionality described for the processor 705 is split among two or more processors such as a baseband processor and an applications processor. The exemplary embodiments may be implemented in any of these or other configurations of a UE.

The memory arrangement 710 may be a hardware component configured to store data related to operations performed by the UE 110. The display device 715 may be a hardware component configured to show data to a user while the I/O device 720 may be a hardware component that enables the user to enter inputs. The display device 715 and the I/O device 720 may be separate components or integrated together such as a touchscreen. The transceiver 725 may be a hardware component configured to establish a connection with the NG RAN 120, an LTE-RAN (not pictured), a legacy RAN (not pictured), a WLAN (not pictured), etc. Accordingly, the transceiver 725 may operate on a variety of different frequencies or channels (e.g., set of consecutive frequencies).

### EXAMPLES

In a first example, a. method is performed by a user equipment (UE) comprising a terminal equipment (TE), a mobile termination (MT) and a terminal adapter (TA), the method comprising transmitting, by the TE, an attention (AT) command for quality of experience (QoE) application layer configuration to the TA, wherein the AT command is configured to control a presentation of an unsolicited return code in response to a radio resource control (RRC) message received by the UE from a network comprising an application layer measurement configuration information element (IE) and receiving, by the TE, the unsolicited result code comprising one or more parameters related to new radio (NR) QoE application layer measurements and associated with a measurement configuration application layer ID, wherein the one or more parameters in the unsolicited result code are received from the network in the application layer measurement configuration IE.

In a second example, the method of the first example, wherein the application layer measurement configuration IE is configured to release a radio access network (RAN) visible application layer measurement configuration.

In a third example, the method of the second example, wherein the one or more parameters include a RAN visible parameter indicating that the unsolicited result code is related to a release of the RAN visible application layer measurement configuration.

In a fourth example, the method of the first example, wherein the application layer measurement configuration IE is configured to indicate an application layer measurement configuration and wherein the one or more parameters include a measurement configuration application layer identification parameter that identifies an application layer measurement configuration related to the unsolicited result code.

In a fifth example, the method of the first example, wherein the application layer measurement configuration IE is configured to setup a radio access network (RAN) visible application layer measurement configuration and wherein the one or more parameters include a RAN visible parameter indicating that the unsolicited result code is related to a setup of the RAN visible application layer measurement configuration.

In a sixth example, the method of the fifth example, wherein the one or more parameters further comprise a parameter indicating whether the UE is to transmit indications of when sessions in an application layer start and stop.

In a seventh example, the method of the sixth example, wherein when a session has already started in the application layer, the UE is triggered to transmit a session start indication.

In an eighth example, the method of the fifth example, wherein the one or more parameters further comprise a parameter indicating a periodicity of RAN visible reporting.

In a ninth example, the method of the fifth example, wherein the one or more parameters further comprise a parameter indicating whether the UE is to report an initial playout delay for RAN visible application layer measurements.

In a tenth example, the method of the fifth example, wherein the one or more parameters further comprise a parameter indicating a maximum number of buffer level entries to be reported for RAN visible application layer measurements.

In an eleventh example, the method of the fifth example, wherein the one or more parameters further comprise a parameter a parameter indicating a type of application layer measurement to be performed.

In a twelfth example, one or more processors configured to perform any of the methods of the first through eleventh examples.

In a thirteenth example, a user equipment (UE) comprising a transceiver configured to communicate with a network and one or more processors communicatively coupled to the transceiver and configured to perform any of the methods of the first through eleventh examples.

In a fourteenth example, a method is performed by one or more processors of a user equipment (UE) comprising a terminal equipment (TE), a mobile termination (MT) and a terminal adapter (TA), the method comprising transmitting, by the TE, an attention (AT) command for quality of experience (QoE) measurement reporting to the TA, wherein the AT command comprises one or more parameters including a parameter identifying an application layer measurement, the one or more parameters configured to set parameters for the UE to include in an application layer measurement report and transmitting a radio resource control (RRC) message to a next generation (NG) radio access network (RAN) comprising a measurement report application layer message based on the AT command.

In a fifteenth example, the method of the fourteenth example, wherein the one or more parameters of the AT command further comprise a parameter indicating whether a QoE session in the UE starts or stops.

In a sixteenth example, the method of the fourteenth example, wherein the one or more parameters of the AT command further comprises a parameter indicating when a session has already started in an application layer, wherein the UE is triggered to transmit a session start or stop indication.

In a seventeenth example, the method of the fourteenth example, wherein the one or more parameters of the AT command further comprise a parameter indicating whether the UE is to report initial playout delay for RAN visible application later measurements.

In an eighteenth example, the method of the fourteenth example, wherein the one or more parameters of the AT command further comprise a parameter indicating a maximum number of buffer level entries to be reported for RAN visible application layer measurements.

In a nineteenth example, the method of the eighteenth example, wherein the one or more parameters of the AT command further comprise a parameter indicating an application layer buffer level, wherein the parameter is indicated in milliseconds (ms).

In a twentieth example, the method of the fourteenth example, wherein the one or more parameters of the AT command further comprise one or more numeric parameters specifying a 5G system (5GS) quality of service (QoS) flow, wherein the numeric parameter is local to a TE-MT interface.

In a twenty first example, the method of the fourteenth example, wherein the one or more parameters of the AT command further comprise a number of protocol data unit (PDU) sessions.

In a twenty second example, the method of the twenty first example, wherein the one or more parameters of the AT command further comprise a PDU session identification for each of the number of PDU sessions.

In a twenty third example, one or more processors configured to perform any of the methods of the fourteenth through twenty second examples.

In a twenty fourth example, a user equipment (UE) comprising a transceiver configured to communicate with a network and one or more processors communicatively coupled to the transceiver and configured to perform any of the methods of the fourteenth through twenty second examples.

Those skilled in the art will understand that the above-described exemplary embodiments may be implemented in any suitable software or hardware configuration or combination thereof. An exemplary hardware platform for implementing the exemplary embodiments may include, for example, an Intel x86 based platform with compatible operating system, a Windows OS, a Mac platform and MAC OS, a mobile device having an operating system such as iOS, Android, etc. The exemplary embodiments of the above described method may be embodied as a program containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

What is claimed:

1. One or more processors of a user equipment (UE) comprising a terminal equipment (TE), a mobile termination (MT) and a terminal adapter (TA), the one or more processors configured to perform operations comprising:
transmitting, by the TE, an attention (AT) command for quality of experience (QoE) application layer configuration to the TA, wherein the AT command is configured to control a presentation of an unsolicited return code in response to a radio resource control (RRC) message received by the UE from a network comprising an application layer measurement configuration information element (IE); and
receiving, by the TE, the unsolicited result code comprising one or more parameters related to new radio (NR) QoE application layer measurements and associated with a measurement configuration application layer ID, wherein the one or more parameters in the unsolicited result code are received from the network in the application layer measurement configuration IE.

2. The one or more processors of claim 1, wherein the application layer measurement configuration IE is configured to release a radio access network (RAN) visible application layer measurement configuration.

3. The one or more processors of claim 2, wherein the one or more parameters include a RAN visible parameter indicating that the unsolicited result code is related to a release of the RAN visible application layer measurement configuration.

4. The one or more processors of claim 1, wherein the application layer measurement configuration IE is configured to indicate an application layer measurement configuration and wherein the one or more parameters include a measurement configuration application layer identification parameter that identifies an application layer measurement configuration related to the unsolicited result code.

5. The one or more processors of claim 1, wherein the application layer measurement configuration IE is configured to setup a radio access network (RAN) visible application layer measurement configuration and wherein the one or more parameters include a RAN visible parameter indicating that the unsolicited result code is related to a setup of the RAN visible application layer measurement configuration.

6. The one or more processors of claim 5, wherein the one or more parameters further comprise a parameter indicating whether the UE is to transmit indications of when sessions in an application layer start and stop.

7. The one or more processors of claim 6, wherein when a session has already started in the application layer, the UE is triggered to transmit a session start indication.

8. The one or more processors of claim 5, wherein the one or more parameters further comprise a parameter indicating a periodicity of RAN visible reporting.

9. The one or more processors of claim 5, wherein the one or more parameters further comprise a parameter indicating whether the UE is to report an initial playout delay for RAN visible application layer measurements.

10. The one or more processors of claim 5, wherein the one or more parameters further comprise a parameter indicating a maximum number of buffer level entries to be reported for RAN visible application layer measurements.

11. The one or more processors of claim 5, wherein the one or more parameters further comprise a parameter a parameter indicating a type of application layer measurement to be performed.

12. One or more processors of a user equipment (UE) comprising a terminal equipment (TE), a mobile termination (MT) and a terminal adapter (TA), the one or more processors configured to perform operations comprising:
transmitting, by the TE, an attention (AT) command for quality of experience (QoE) measurement reporting to the TA, wherein the AT command comprises one or more parameters including a parameter identifying an application layer measurement, the one or more parameters configured to set parameters for the UE to include in an application layer measurement report; and
transmitting a radio resource control (RRC) message to a next generation (NG) radio access network (RAN) comprising a measurement report application layer message based on the AT command.

13. The one or more processors of claim 12, wherein the one or more parameters of the AT command further comprise a parameter indicating whether a QoE session in the UE starts or stops.

14. The one or more processors of claim 12, wherein the one or more parameters of the AT command further comprises a parameter indicating when a session has already started in an application layer, wherein the UE is triggered to transmit a session start or stop indication.

15. The one or more processors of claim 12, wherein the one or more parameters of the AT command further comprise a parameter indicating whether the UE is to report initial playout delay for RAN visible application later measurements.

16. The one or more processors of claim 12, wherein the one or more parameters of the AT command further comprise a parameter indicating a maximum number of buffer level entries to be reported for RAN visible application layer measurements.

17. The one or more processors of claim 16, wherein the one or more parameters of the AT command further comprise a parameter indicating an application layer buffer level, wherein the parameter is indicated in milliseconds (ms).

18. The one or more processors of claim 12, wherein the one or more parameters of the AT command further comprise one or more numeric parameters specifying a 5G system (5GS) quality of service (QoS) flow, wherein the numeric parameter is local to a TE-MT interface.

19. The one or more processors of claim 12, wherein the one or more parameters of the AT command further comprise a number of protocol data unit (PDU) sessions.

20. The one or more processors of claim 19, wherein the one or more parameters of the AT command further comprise a PDU session identification for each of the number of PDU sessions.
